(19) United States
(12) Patent Application Publication
(10) Pub. No.: US 2012/0113150 A1
(43) Pub. Date: May 10, 2012

(54) MULTIMEDIA COMMUNICATION APPARATUS AND PROCESSING METHOD FOR GROUP MEDIA COMMUNICATION

(75) Inventors: Seon-Tae KIM, Daejeon (KR); Misun Yu, Daejeon (KR); Ji Young Kwak, Daejeon (KR); Pyeong Soo Mah, Daejeon (KR)

(73) Assignee: Electronics and Telecommunications Research Institute, Daejeon (KR)

(21) Appl. No.: 13/287,532

(22) Filed: Nov. 2, 2011

(30) Foreign Application Priority Data
Nov. 4, 2010 (KR) 10-2010-0109110

(51) Int. Cl. G06F 12/02; G09G 5/36; G09G 5/00

(52) U.S. Cl. 345/660

(57) ABSTRACT

A multimedia communication apparatus for group media communication includes an encoding unit for receiving source data from an input device, capturing and compressing the source data at a specific display resolution, and sending the compressed data via network communication. Further, the multimedia communication apparatus for the group media communication includes a plurality of decoding units for receiving the compressed data via the network communication, restoring the compressed data into original data so that a user can view and listen to the data, and providing the original data to an output device. Furthermore, the multimedia communication apparatus for the group media communication includes a group communication management unit for activating at least one decoding unit selected from among the plurality of decoding units, adjusting and setting the display resolution, and adjusting a size of the memory and allocating memory of the adjusted size.

### CROSS-REFERENCE TO RELATED APPLICATION(S)

The present invention claims priority of Korean Patent Application No. 10-2010-0109110, filed on Nov. 4, 2010, which is incorporated herein by references.

### FIELD OF THE INVENTION

The present invention relates to a multimedia communication apparatus and processing method for group media communication; and, more particularly, to a multimedia communication apparatus which is capable of providing an optimum display environment when a plurality of users forms a group and then performs multimedia communication and a multimedia communication processing method including a memory allocation process therefor.

### BACKGROUND OF THE INVENTION

As is well known, thanks to the improving performance of digital mobile information devices, multimedia application technologies which enable users to view videos while moving or to manage captured and stored photos are being widely used. Furthermore, thanks to the popularization of the wireless Internet, services which enable users to send and receive large amounts of multimedia data are being provided.

With the development of such multimedia technologies, in mobile communication, multimedia communication services based on audio and video, rather than existing communication services based on audio transmission, are being currently provided.

Multimedia communication services are made possible by the implementation of multimedia communication apparatuses which have the ability to enable encoding and decoding to be performed at the same time and also to enable large amounts of data to be sent and received. Furthermore, group media communication services which enable multiple users to form a group and then perform multimedia communication, like voice conference call services, can be provided.

Meanwhile, when group media communication services are provided, the resolution at which a user's own video or a counterpart's video is displayed significantly influences Quality of Service (QoS). For example, even a multimedia communication apparatus which can support Video Graphics Array (VGA) resolution may display counterparts' videos at Quarter Video Graphics Array (QVGA) resolution when displaying all multiple users' videos, in which case a user is provided with QVGA-level multimedia communication service, even though the users has a VGA-level multimedia communication apparatus.

### SUMMARY OF THE INVENTION

In view of the above, the present invention provides a multimedia communication apparatus and processing method for group media communication, which is capable of variably setting display resolution in conformity with the number of members who participate in group media communication, thereby minimizing a reduction in the QoS of group media communication.

Further, the present invention provides a multimedia communication apparatus and processing method for group media communication, which is capable of providing continuous video while varying display resolution when the number of members who is participating in group media communication changes.

In accordance with a first aspect of the present invention, there is provided a multimedia communication apparatus for group media communication. The multimedia communication apparatus for the group media communication includes an encoding unit for receiving source data from an input device, capturing and compressing the source data at a specific display resolution set based on reference information for each multimedia communication mode, and sending the compressed data via network communication; a plurality of decoding units for receiving the compressed data via the network communication, restoring the compressed data into original data so that a user can view and listen to the data using memory allocated based on the reference information for each multimedia communication mode, and providing the original data to an output device; and a group communication management unit for activating at least one decoding unit selected from among the plurality of decoding units, adjusting and setting the display resolution, and adjusting a size of the memory and allocating memory of the adjusted size, based on the reference information for each multimedia communication mode varied in conformity with a number of members who are participating in the multimedia communication service.

In accordance with a second aspect of the present invention, there is provided a multimedia communication processing method for group media communication. The multimedia communication processing method for the group media communication includes setting a display resolution while allocating buffer memory for an encoding process or a decoding process, in conformity with a number of members who are participating in a multimedia communication service; checking again the number of members while performing encoding, decoding and playback using the allocated buffer memory; if the number of members has been changed, allocating new buffer memory and changing the setting of the display resolution, in conformity with the changed number of members; determining whether data remains in the existing buffer memory, and, if data remains, storing data in the new buffer memory while playing back the data remaining in the existing buffer memory; and if data does not remain in the existing buffer memory, releasing the existing buffer memory, and storing data in the new buffer memory while playing back the data stored in the new buffer memory.

In accordance with an embodiment of the present invention, the display resolution is set in conformity with the number of members who are participating in group media communication and buffer memory is allocated accordingly, thereby minimizing deterioration in the QoS of group media communication. Furthermore, a data path which is used to play data stored in buffer memory is adjusted when the number of members who are participating in group media communication changes, thereby enabling continuous video to be provided.

### BRIEF DESCRIPTION OF THE DRAWINGS

The objects and features of the present invention will become apparent from the following description of embodiments given in conjunction with the accompanying drawings, in which:

FIG. 1 is a block diagram of a multimedia communication apparatus in accordance with an embodiment of the present invention;

FIG. 2 is a detailed block diagram of an encoding unit in accordance with the embodiment of the present invention;

FIG. 3 is a detailed block diagram of a decoding unit in accordance with the embodiment of the present invention;

FIG. 4 is a detailed block diagram of a group communication management unit in accordance with an embodiment of the present invention;

FIG. 5 is a flowchart illustrating a multimedia communication processing method, which is performed by the multimedia communication apparatus, according to an embodiment of the present invention;

FIG. 6 is a diagram showing an example of a screen window for two persons according to an embodiment of the present invention; and

FIG. 7 is a diagram showing an example of a screen window for four persons according to an embodiment of the present invention.

### DETAILED DESCRIPTION OF THE EMBODIMENTS

Hereinafter, embodiments of the present invention will be described in detail with reference to the accompanying drawings which form a part hereof.

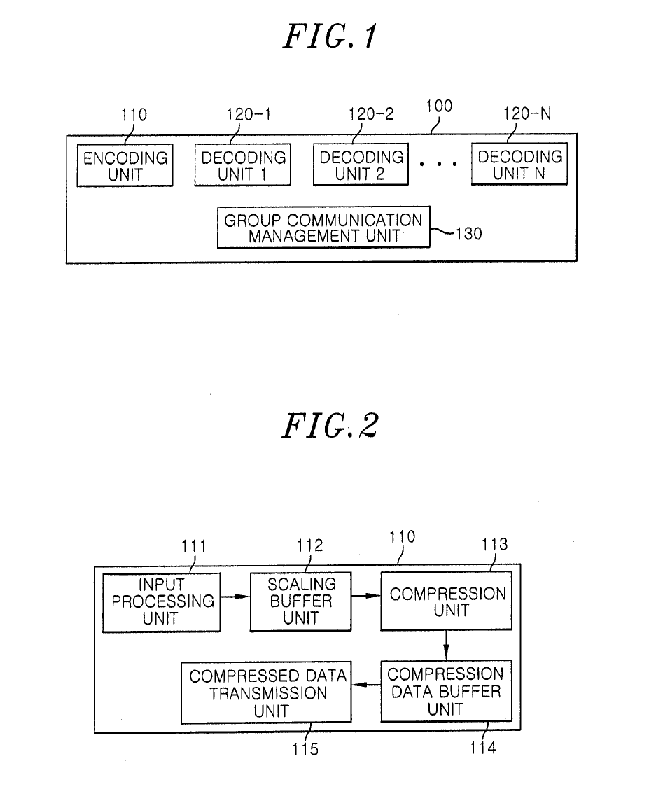

FIG. 1 is a block diagram of a multimedia communication apparatus 100 in accordance with an embodiment of the present invention.

As shown in FIG. 1, the multimedia communication apparatus 100 in accordance with the embodiment includes an encoding unit 110, decoding units 1 to N 120-1 to 120-N, and a group communication management unit 130.

The encoding unit 110 compresses source data, received from an input device, such as a camera or a microphone, using a specific compression codec suitable for a relevant service, and sends the compressed data via network communications. This encoding unit 110 captures source data at a specific resolution according to the display resolution set based on reference information for each multimedia communication mode.

The decoding units 1 to N 120-1 to 120-N restores the compressed data, received via network communication, to the original data so that a user can view and listen to it, and provides it to an output device. These decoding units 1 to N 120-1 to 120-N use memory allocated based on the reference information for each multimedia communication mode.

The group communication management unit 130 selectively creates and removes the decoding units 1 to N 120-1 to 120-N or selectively activates and deactivates them, depending on the variations in members who participate in group communication. For example, in order to communicate with a plurality of users in group communication, M−1 decoding units need to be operated when the number of members which participate in group media communication is M, the group communication management unit 130 manages the decoding units 1 to N 120-1 to 120-N so that at least one decoding unit is operated in conformity with the number of members who participate in group communication. The group communication management unit 130 adjusts and then allocates the size of buffer memory while selectively activating at least one of the decoding units 1 to N 120-1 to 120-N and adjusting and then setting the display resolution, based on the reference information for each multimedia communication mode, which varies according to the number of members who participate in group media communication.

FIG. 2 is a detailed block diagram of the encoding unit 110 in accordance with an embodiment of the present invention.

As shown in FIG. 2, the encoding unit 110 in accordance with the embodiment includes an input processing unit 111, a scaling buffer unit 112, a compression unit 113, a compressed data buffer unit 114, and a compressed data transmission unit 115.

The input processing unit 111 captures source data input from the input device, such as a camera or a microphone, and stores the captured source data in the scaling buffer unit 112.

The compression unit 113 compresses a massive amount of multimedia source data, stored in the scaling buffer unit 112, in conformity with the resolution and network bandwidth desired by a user, and stores the compressed data in the buffer unit 114. For this purpose, the compression unit 113 includes an audio compression codec and a video compression codec which are used to compress each piece of multimedia input data in conformity with its characteristics.

The compressed data transmission unit 115 converts the compressed multimedia data, compressed by the compression unit 113 and stored in the compressed data buffer unit 114, into packets suitable for a relevant protocol, and then sends the packets via network communication.

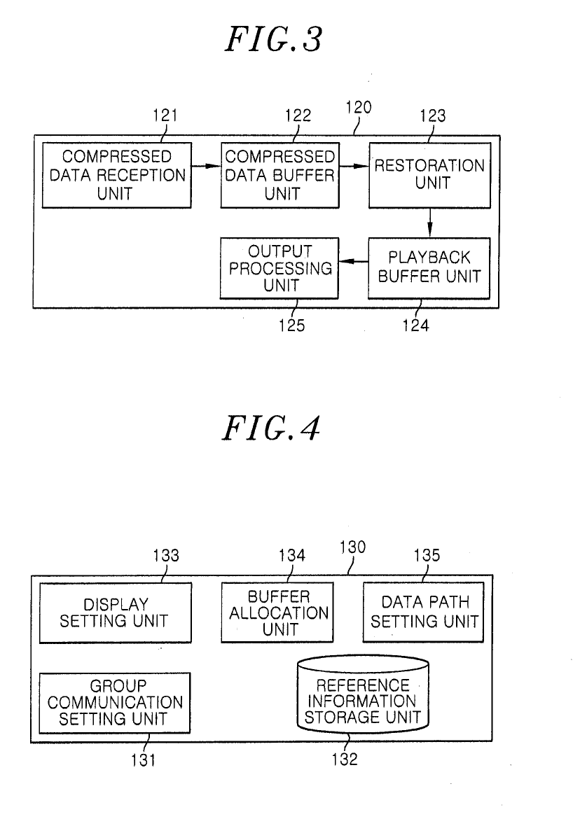

FIG. 3 is a detailed block diagram of the decoding unit 120 in accordance with the embodiment of the present invention. Here, reference numeral 120 collectively denotes the decoding units 1 to N 120-1 to 120-N. Each of the decoding units 1 to N 120-1 to 120-N may have the following configuration.

As shown in FIG. 3, the decoding unit 120 in accordance with the embodiment includes a compressed data reception unit 121, a compressed data buffer unit 122, a restoration unit 123, a playback buffer unit 124, and an output processing unit 125.

The compressed data reception unit 121 receives the compressed multimedia data via network communication, checks for compressed bitstream error, packet loss and incorrect packet sequencing which may occur in a network, converts compressed multimedia data into correct data by performing error recovery or re-sequencing, and stores the correct data in the compressed data buffer unit 124.

The restoration unit 123 releases the compression of the compressed stream arranged in the compressed data buffer unit 122, creates source data, and stores the created source data in the playback buffer unit 124.

The output processing unit 125 provides the data stored in the playback buffer unit 124 to the output device, such as a speaker or a display window, so that the data can be output to the outside.

Meanwhile, in a group media communication service, when the number of participating members changes, a video output device and the like may not be effectively used if output is performed at a fixed resolution regardless of such a variation. That is, if video output resolution is adjusted in conformity with the maximally supported number of members and then services are provided regardless of fixed 1 to 1 multimedia communication or group communication, for example, regardless of whether the number of members participating in multimedia communication one or four, high resolution can be provided for 1 to 1 multimedia communication, but low resolution services are provided on average.

Accordingly, in order to provide group communication service having the optimum or best video output in conformity with the variation in the number of members participating in multimedia communication, such as 1 to 1, 2 to 2 or N to N communication, the source data captured by the encoding unit 110 needs to be regenerated, options for optimizing the resolution and image quality of the encoding unit 110 and the decoding unit 120 needs to be adjusted. The functionality of adjusting or changing such a multimedia communication service environment may be performed by the group communication management unit 130.

FIG. 4 is a detailed block diagram of the group communication management unit 130 in accordance with an embodiment of the present invention.

As shown in FIG. 4, the group communication management unit 130 according to the embodiment includes a group communication setting unit 131, a reference information storage unit 132, a display setting unit 133, a buffer allocation unit 134, and a data path setting unit 135.

The reference information storage unit 132 stores reference information for each multimedia communication mode, which varies depending on the number of members who participate in a multimedia communication service.

The group communication setting unit 131 checks the number of members M who participate in a multimedia communication service, extracts reference information for each multimedia communication mode corresponding to the number of members M from the reference information storage unit 132, and activates a specific number of (M−1) decoding units selected from among the plurality of decoding units based on the extracted reference information for each multimedia communication mode.

The display setting unit 133 adjusts and then sets the display resolution of the encoding unit 110 or decoding unit 120 based on the reference information for each multimedia communication mode which is extracted by the group communication setting unit 131.

The buffer allocation unit 134 adjusts the size of memory to be allocated to the encoding unit 110 or decoding unit 120 based on the reference information for each multimedia communication mode which is extracted by the group communication setting unit 131.

The data path setting unit 135 checks whether data remains in previously allocated buffer memory when the number of members who participate in multimedia communication service has changed and then the group communication management unit 130 has newly allocated memory, sets up a data path for playing back the data stored in the memory so that the remaining data can be first played back, and sets up a data path so that data stored in the newly allocated memory can be played back after all the remaining data has been played back.

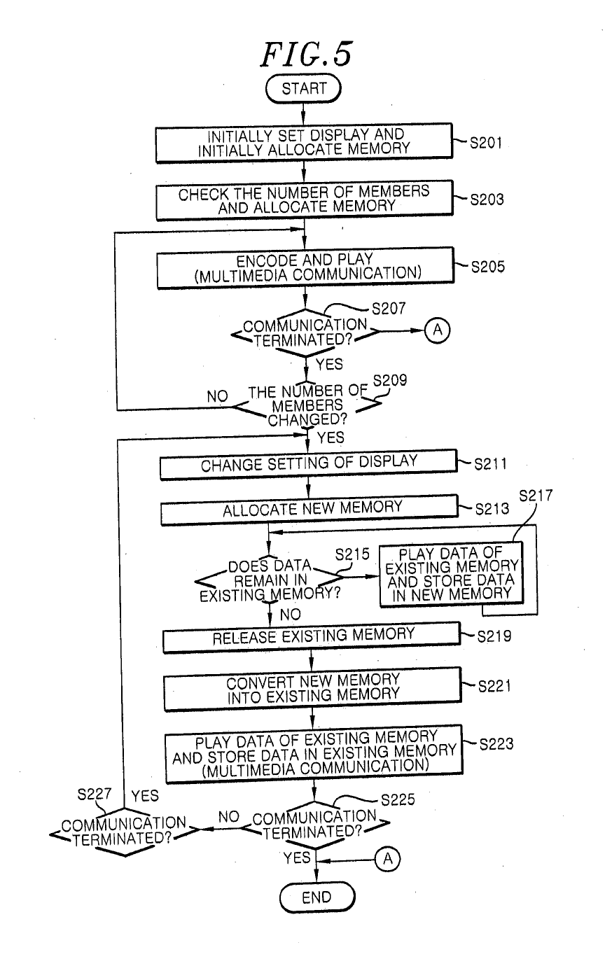

FIG. 5 is a flowchart illustrating a multimedia communication processing method, which is performed by the multimedia communication apparatus, in accordance with an embodiment of the present invention.

As shown in FIG. 5, the multimedia communication processing method according to this embodiment includes steps S201 to S205 of allocating buffer memory which is used either in an encoding process of capturing source data provided by an input device at a specific resolution and compressing and then sending the captured data, or in a decoding process of restoring received compressed data to original data and providing the original data to an output device, in conformity with the number of members who participate in multimedia communication service, and setting a display resolution for the encoding process or the decoding process; steps S207 and S209 of checking again the number of members who participate in the multimedia communication service while performing encoding, decoding and playback using the allocated buffer memory; steps S211 and S213 of, if the number of members who participate in the multimedia communication service is changed, allocating new buffer memory and changing the setting of the display resolution, in conformity with the changed number of members; steps S215 and S217 of determining whether data remains in the existing buffer memory, and, if data remains, storing data in the new buffer memory while playing back the data remaining in the existing buffer memory; and steps S219 to S227 of, if data does not remain in the existing buffer memory, releasing the existing buffer memory, and storing data in the new buffer memory while playing back the data stored in the new buffer memory.

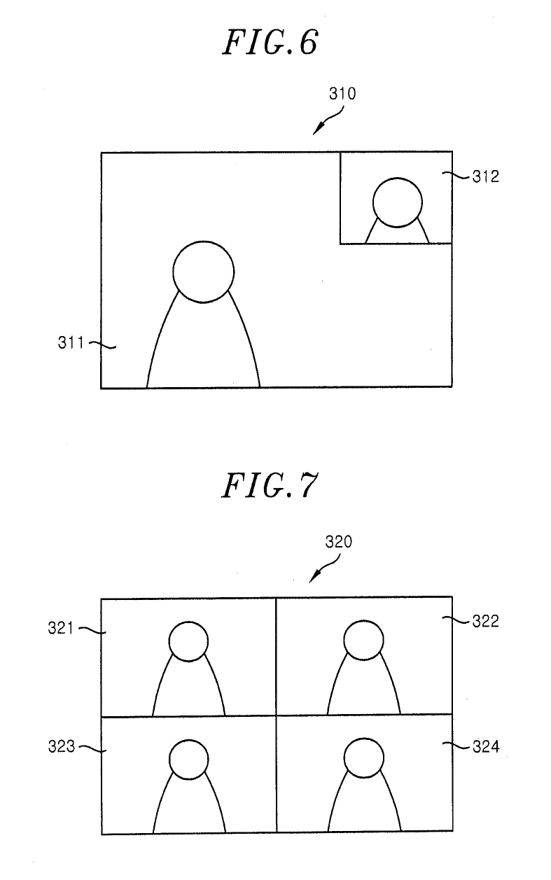

FIG. 6 is a diagram showing an example of a screen window for two persons according to an embodiment of the present invention, and FIG. 7 is a diagram showing an example of a screen window for four persons in accordance with an embodiment of the present invention.

Referring to FIGS. 1 to 7, a multimedia communication processing procedure, which is performed by the multimedia communication apparatus, in accordance with an embodiment of the present invention will now be described in more detail.

In accordance with the embodiment of the present invention, media processing is performed to actively convert corresponding buffers, that is, the scaling buffer unit 112, the compressed data buffer unit 114, the compressed data buffer unit 122, and the playback buffer unit 124, in response to the dynamic participation or withdrawal of one or more group members in or from group media communication.

If group media communication has been initiated and memory has been allocated in conformity with the number of members to achieve optimum communication, the number of pieces of data which needs to be received by each multimedia communication apparatus 100 is changed when the number of members who are participating in the existing group media communication increases or decreases, so that memory needs to be allocated to be suited for the changed number of pieces of data. For this purpose, buffer memory needs to be newly allocated and the existing buffer memory needs to be released. In this description, the active allocation of memory based on the increase or decrease in the number of members will be described in relation to video data, and another type of memory allocation will be additionally described.

A first step is a step of setting the optimum display. In the case of video, the resolution is varied according to the number of members who is participating in output group media communication. When the number of members is changed, the resolution needs to be adjusted in conformity with the situation. That is, for 1 to 1 multimedia communication basically performed over a third generation (3G) network, an counterpart's screen is played on a first screen 311 and a user's own screen is provided in a second screen 312 (for example, a small screen) in preview form, like in a screen window for two persons 310 shown in FIG. 6, or there may be no user's own screen and only a counterpart's screen may be provided. In contrast, when a plurality of users is participating in group media communication, four persons may be displayed at the same size, like in the screen window for four persons 320 shown in FIG. 7, or they may be displayed in different sizes according to importance. In these situations, the setting of the optimum display is performed, and the amount of memory used varies accordingly.

When the number of members is changed, there is the case where the setting of the optimum display needs to be changed. In a second step, new memory needs to be allocated in conformity with the optimum setting. For example, when the resolution needs to be adjusted to the QVGA resolution because of an increase in the number of members, like in the screen window for four persons 320 shown in FIG. 7, while multimedia communication is being performed at the VGA resolution, like in the screen window for two persons 310 shown in FIG. 6, the encoding unit 110 requires QVGA encoding rather than VGA resolution encoding, the decoding unit 120 needs to create or activate a number of decoding units equal to the number of added members, and the existing VGA playback buffer needs to be replaced with the QVGA playback buffer. In contrast, when four persons participate in multimedia communication and then the number of persons is decreased, the allocation of the buffers needs to be reset in the opposite manner.

At a third step, whether data remains in the existing buffer memory needs to be determined and a data path for playing back video needs to be set up. The data compressed by the previously created encoding unit 110 or decoding unit 120 has been stored in the existing buffer memory. If this data is discarded, continuity is broken and therefore a video is interrupted. Accordingly, it is determined whether all the stored data has been transmitted by the transmission part or all the stored data has been played by the playback part, and, if data remains in the existing buffer memory, the operation of playing the data remaining in the existing buffer memory while storing received data in new memory needs to be performed. As a result, if all the data stored in the existing buffer memory has been exhausted, the new memory needs to be accessed.

At a fourth step, if data stored in existing buffer memory is all exhausted, the existing buffer memory is released and then data stored in new memory needs to be played back. Although the existing data is used to provide continuity related to the existing stored data after the settings have been changed, received data is stored in the newly allocated memory area because playback is performed based on the newly changed settings. The previously allocated existing memory which has been rendered obsolete because all the stored data has been exhausted is released, and is then allowed to be used as another program area.

Meanwhile, even the same video may exhibit different compressed data bit rates depending on the resolution or the image quality, and the allocated buffer size may vary accordingly. However, in the case of audio, the bit rate does not vary depending on the number of members participating in the group communication, so that the encoding unit 110 does not need to take into account audio when new buffer memory is allocated. However, the decoding unit 120 is adjusted depending on the number of members, so that allocating or releasing buffer memory for audio needs to be performed.

To help understand the present invention better, an example will be described below in which the number of members participating in the group media communication changes from four to two.

Assuming that a total of four users called users 1 to 4 perform group media communication, the user 1 sends his or her own audio/video data to all of the users 2 to 4, and receives audio/video data from the users 2 to 4. Each of the other users exchanges audio/video data with the other users based on each of the other users. In this case, the multimedia communication apparatus 100 is managed in conformity with a four-person group media communication environment, and the videos of users 1 to 4 are played at the same size, like in the screen window for four persons 320 shown in FIG. 7. For example, the resolution of screen 1 321 to screen 4 324 is set to QVGA resolution.

Meanwhile, reference information for each mode which is used to control or manage the operation of the encoding unit 110 and the decoding unit 120 for each mode of the group media communication is previously stored in the reference information storage unit 132 of the group communication management unit 130, and the group communication setting unit 131, display setting unit 133, buffer allocation unit 134 and data path setting unit 135 of the group communication management unit 130 control or manage the operation of the encoding unit 110 and the decoding unit 120 based on the previously stored reference information for each mode.

When multimedia communication is requested at the step S201 of initially setting the display and initially allocating the memory, the group communication setting unit 131 checks for any change in the number of members who are participating in the multimedia communication service, and drives or activates three of the decoding units 1 to N 120-1 to 120-N based on the reference information for each mode corresponding to the number of members. The display setting unit 133 sets the display environments of the encoding unit 110 and the decoding unit 120 in conformity with the screen window for four persons 320 shown in FIG. 7 based on the reference information for each mode, so that the input processing unit 111 of the encoding unit 110 captures source data, input via an input device, at the resolution suitable for the screen window for four persons 320 and then stores the captured data in the scaling buffer unit 112. For this purpose, the buffer allocation unit 134 of the group communication management unit 130 allocates appropriate memory to the scaling buffer unit 112, the compressed data buffer unit 114, the compressed data buffer unit 122 and the playback buffer unit 124 based on the reference information for each mode so that data with a resolution suitable for the screen window for four persons 320 can be stored at step S203.

In the situation of the display setting and the memory allocation, encoding, decoding and playback are performed by the encoding unit 110, the decoding unit 120 and an output device, respectively, so that group media communication service is provided among the users at step S205.

Meanwhile, when the multimedia communication is not terminated, the group communication management unit 130 needs to check for any change in the number of members who are participating in the multimedia communication at step S209, and, if the number of members participating in the multimedia communication has changed, needs to control or manage the operation of the encoding unit 110 and the decoding unit 120 in conformity with the changed number of members.

For example, when two members who were participating in group media communication terminate multimedia communication and the communication environment changes to a two-person multimedia communication environment, the group communication setting unit 131, display setting unit 133, buffer allocation unit 134 and data path setting unit 135 of the group communication management unit 130 controls or manages the operation of the encoding unit 110 and the decoding unit 120 in conformity with the two-person multimedia communication environment based on the previously stored reference information for each mode.

The group communication setting unit 131 drives or activates one of the decoding units 1 to N 120-1 to 120-N based on the reference information for each mode. The display setting unit 133 sets the display environments of the encoding unit 110 and the decoding unit 120 in conformity with the screen window for two persons 310 shown in FIG. 6 based on the reference information for each mode at step S211, so that the input processing unit 111 of the encoding unit 110 captures source data, input via the input device, at the resolution suitable for the screen window for two persons 310, and then stores the captured data in the scaling buffer unit 112. For this purpose, the buffer allocation unit 134 of the group communication management unit 130 allocates appropriate memory to the scaling buffer unit 112, the compressed data buffer unit 114, the compressed data buffer unit 122 and the playback buffer unit 124 based on the reference information for each mode so that data with a resolution suitable for the screen window for two persons 310 can be stored at step S213.

For example, when in the screen window for two persons 310 shown in FIG. 6, the resolution of the screen 1 311 is set to the VGA resolution and the resolution of the screen 2 312 is set to the QVGA resolution, the input processing unit 111 of the encoding unit 110 captures source data, input via an input device, at the VGA resolution and then stores the captured data in the scaling buffer unit 112.

Meanwhile, if the memory allocated before a change is immediately released when the memory allocation state of the scaling buffer unit 112, the compressed data buffer unit 114, the compressed data buffer unit 122 and the playback buffer unit 124 is changed because of the change in the number of members who are participating in the multimedia communication, the data stored in the allocated memory is discarded, so that a phenomenon in which an output video is interrupted.

Accordingly, the data path setting unit 135 of the group communication management unit 130 checks whether data remains in the memory previously allocated to the scaling buffer unit 112, the compressed data buffer unit 114, the compressed data buffer unit 122 and the playback buffer unit 124 at step S215.

If data remains in the existing buffer memory, the data path is set up such that the data remaining in the existing buffer memory can be played, and the operation of storing data in new buffer memory while first playing the remaining data is performed at step S217. For example, when several frames are stored in the buffer memory in order to enable smooth playback and then encoding or decoding is performed, step S217 is repeated until all the frames remaining in buffer memory have been played.

When all the data stored in the existing buffer memory is completely played, notification of this state is provided to the buffer allocation unit 134, and the buffer allocation unit 134 releases the previously allocated memory at step S219.

Thereafter, the data stored in the new buffer memory is played in the encoding or decoding process, and data is also stored in the new buffer memory. Here, since encoding or decoding data has been already stored in the new buffer memory, the new buffer memory may be referred to as “existing (or previously allocated) buffer memory.” This will now be described with reference to the embodiment of FIG. 5. For example, the new buffer memory allocated at step S213 is converted into existing buffer memory at step S221. Thereafter, the operation of storing data in the existing buffer memory while playing the data stored in the existing buffer memory is performed, like in a normal state, and then group media communication service is provided, like in step S205, in step S223.

After step S223 has been performed, it is determined whether the multimedia communication has been terminated, like in step S207, in step S225. If the multimedia communication has not been terminated, it is determined whether the number of members who are participating in the group has changed in step S227, and, if the number of members has changed, steps S211 to S225 needs to be repeated.

While the invention has been shown and described with respect to the embodiments, it will be understood by those skilled in the art that various changes and modifications may be made without departing from the scope of the invention as defined in the following claims.

What is claimed is:

1. A multimedia communication apparatus for group media communication, comprising:
an encoding unit for receiving source data from an input device, capturing and compressing the source data at a specific display resolution set based on reference information for each multimedia communication mode, and sending the compressed data via network communication;
a plurality of decoding units for receiving the compressed data via the network communication, restoring the compressed data into original data so that a user can view and listen to the data using memory allocated based on the reference information for each multimedia communication mode, and providing the original data to an output device; and
a group communication management unit for activating at least one decoding unit selected from among the plurality of decoding units, adjusting and setting the display resolution, and adjusting a size of the memory and allocating memory of the adjusted size, based on the reference information for each multimedia communication mode varied in conformity with a number of members who are participating in the multimedia communication service.

2. The multimedia communication apparatus of claim 1, wherein the group communication management unit comprises:
a reference information storage unit for storing the reference information for each multimedia communication mode;
a group communication setting unit for checking a number of members who participate in the multimedia communication service, extracting the reference information for each multimedia communication mode corresponding to the number of members from the reference information storage unit, and activating M−1 (where M is the number of members) decoding units selected from among the plurality of decoding units based on the extracted reference information for each multimedia communication mode;
a display setting unit for adjusting and setting the display resolution the reference information for each multimedia communication mode extracted by the group communication setting unit; and
a buffer allocation unit for adjusting a size of the memory based on the reference information for each multimedia communication mode extracted by the group communication setting unit, and then allocating memory of the adjusted size.

3. The multimedia communication apparatus of claim 1, wherein the group communication management unit, if the number of members who participated in the multimedia communication service has been changed and the group communication management unit has newly allocated the memory, determining whether data remains in the previously allocated existing buffer memory, setting up a data path so that the remaining data can be first played if data remains in the existing buffer memory, and setting up a data path so that the data stored in the new buffer memory can be played after all the remaining data has been played.

4. A multimedia communication processing method for group media communication, comprising:
setting a display resolution while allocating buffer memory for an encoding process or a decoding process, in conformity with a number of members who are participating in a multimedia communication service;
checking again the number of members while performing encoding, decoding and playback using the allocated buffer memory;
if the number of members has been changed, allocating new buffer memory and changing the setting of the display resolution, in conformity with the changed number of members;
determining whether data remains in the existing buffer memory, and, if data remains, storing data in the new buffer memory while playing back the data remaining in the existing buffer memory; and
if data does not remain in the existing buffer memory, releasing the existing buffer memory, and storing data in the new buffer memory while playing back the data stored in the new buffer memory.

5. The multimedia communication processing method of claim 4, wherein the setting while allocating or the allocating and changing comprises allocating the buffer memory or setting the display resolution based on reference information for each multimedia communication mode varied in conformity with the number of members.

6. The multimedia communication processing method of claim 4, further comprising:
if data remains in the existing buffer memory, setting up a data path so that the remaining data can be first played, and, after all the remaining data has been played, setting up a data path so that the data stored in the new buffer memory can be played.
